(19) United States
(12) Patent Application Publication
(10) Pub. No.: US 2016/0208955 A1
(43) Pub. Date: Jul. 21, 2016

(54) VALVE ASSEMBLY, WASHER SYSTEM, AND DEVICE

(71) Applicant: GM GLOBAL TECHNOLOGY OPERATIONS LLC, Detroit, MI (US)

(72) Inventors: Nicholas W. Pinto, IV, Shelby Township, MI (US); Paul W. Alexander, Ypsilanti, MI (US); Scott R. Webb, Macomb Township, MI (US); Nancy L. Johnson, Northville, MI (US); Richard J. Skurkis, Lake Orion, MI (US)

(73) Assignee: GM GLOBAL TECHNOLOGY OPERATIONS LLC, Detroit, MI (US)

(21) Appl. No.: 14/995,792

(22) Filed: Jan. 14, 2016

Related U.S. Application Data
(60) Provisional application No. 62/103,815, filed on Jan. 15, 2015.

(51) Int. Cl. F16K 99/00; F16K 31/00

(52) U.S. Cl. CPC F16K 99/0038; F16K 31/002

(57) ABSTRACT

A valve assembly includes a shuttle reversibly translatable with respect to an axis. The shuttle defines an at least first outlet port, an at least second outlet port spaced apart from the at least first outlet port, and an inlet port. The valve assembly includes an actuator configured for translating the shuttle with respect to the axis between a first position in which the at least first outlet port and the inlet port are disposed in fluid communication, and a second position in which the at least second outlet port and the inlet port are disposed in fluid communication. The actuator is formed from a shape memory alloy transitionable between a first state and a second state in response to a thermal activation signal. A washer system, a device, and a method of alternately washing one of a first component and a second component of the device are disclosed.

### CROSS-REFERENCE TO RELATED APPLICATIONS

This application claims the benefit of U.S. Provisional Application No. 62/103,815, filed on Jan. 15, 2015, which is hereby incorporated by reference in its entirety.

### TECHNICAL FIELD

The disclosure relates to a valve assembly of a washer system for a device.

### BACKGROUND

Valves are useful for many applications requiring controlled fluid flow. For example, valves may be used to distribute fluid to portions or components of a device. Such fluid distribution often must be precisely and reliably controlled and/or available on an on-demand basis.

That is, many devices are operated in harsh environments. For example, devices such as vehicles and security cameras may be exposed to dirt, debris, and/or moisture during operation. Such dirt, debris, and/or moisture may be washed away by a fluid that is distributed by one or more valves.

### SUMMARY

A valve assembly includes a shuttle reversibly translatable with respect to an axis. The shuttle defines an at least first outlet port, an at least second outlet port spaced apart from the at least first outlet port, and an inlet port. The valve assembly also includes an actuator configured for translating the shuttle with respect to the axis between a first position in which the at least first outlet port and the inlet port are disposed in fluid communication, and a second position in which the at least second outlet port and the inlet port are disposed in fluid communication. The actuator is formed from a shape memory alloy transitionable between a first state and a second state in response to a thermal activation signal.

A washer system includes a reservoir defining a cavity and configured for storing a fluid within the cavity. The washer system also includes the valve assembly and a pump configured for transmitting the fluid under pressure from the reservoir to the inlet port.

A device includes a first component and a second component spaced apart from the first component and exposed to debris. The device also includes the washer system configured for alternately washing one of the first component and the second component. Further, the device includes a first nozzle disposed in fluid communication with the at least first outlet port and configured for spraying the fluid onto the first component. The device also includes a second nozzle disposed in fluid communication with the at least second outlet port and configured for spraying the fluid onto the second component.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a cutaway, side view of a valve assembly of a wash system of a device, wherein the valve assembly includes a shuttle disposed in a first position in which an at least first outlet port and an inlet port are disposed in fluid communication;

FIG. 2 is a schematic illustration of a cutaway, side view of the valve assembly of FIG. 1, wherein the shuttle is disposed in a second position in which an at least second outlet port and the inlet port are disposed in fluid communication; and

FIG. 3 is a schematic flowchart of a method of alternately washing one of a first component of the device of FIGS. 1 and 2 and a second component of the device.

### DETAILED DESCRIPTION

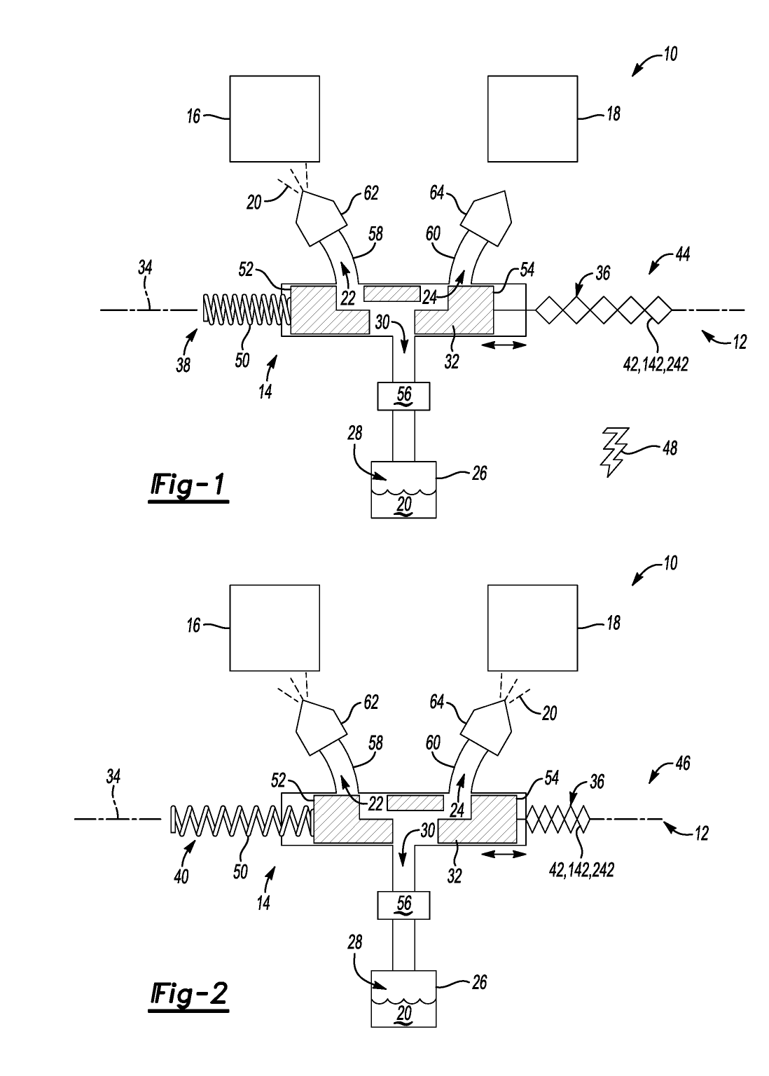

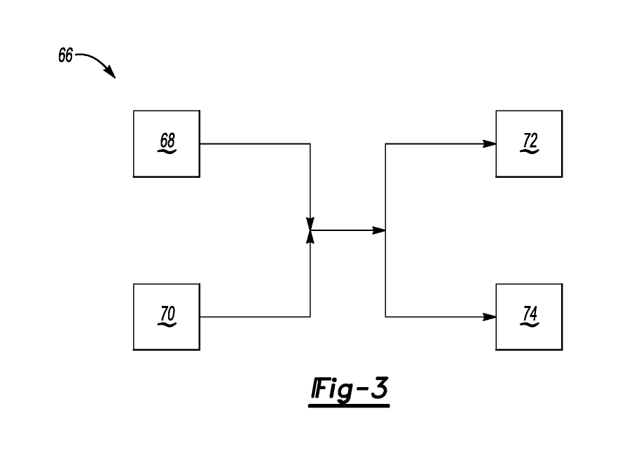

Referring to the Figures, wherein like reference numerals refer to like elements, a device 10 including a washer system 12 that includes a valve assembly 14 is shown generally in FIG. 1. A method 66 of alternately washing one of a first component 16 of the device 10 and a second component 18 of the device 10 is also shown generally in FIG. 3. The valve assembly 14, washer system 12, and method 66 may be useful for devices 10 which require controlled, precise, reliable, and on-demand fluid distribution to specific portions of the device 10. The valve assembly 14 and washer system 12 may minimize fluid backflow and fluid waste, and may accurately seal off unwanted fluid flow to one or more portions of the device 10.

For example, the valve assembly 14 and washer system 12 may be useful for washing only the first component 16 of the device 10 without washing the second component 18. Conversely, the valve assembly 14 and washer system 12 may be useful for washing only the second component 18 of the device 10 without washing the first component 16. That is, the valve assembly 14 may be characterized as a diverter valve. As such, the valve assembly 14 and washer system 12 may be useful for vehicular applications such as automotive vehicles, construction equipment, and aviation applications. The valve assembly 14 and washer system 12 may alternatively be useful for non-vehicular applications such as, but not limited to, residential pressurized fluid distribution, recreational and industrial devices, and security camera monitoring.

Referring now to FIG. 1, the device 10 includes the first component 16 and the second component 18 spaced apart from the first component 16. By way of a non-limiting example, the first component 16 may be a front windshield of a device 10 such as a vehicle. Also by way of non-limiting examples, the second component 18 may be a rear window, a liftgate window, or a camera lens. The second component 18 may be exposed to dirt, dust, moisture, and/or debris during operation of the device 10 and therefore may periodically require washing with a fluid 20, such as water or windshield washer fluid comprising a de-icer, bug remover, solvents, and/or detergents. Alternatively, the fluid 20 may be a valve fluid, such as an oil and/or lubricant. As another non-limiting example, the fluid 20 may be a gas, such as nitrogen.

The device 10 also includes a washer system 12 configured for alternately washing one of the first component 16 and the second component 18. That is, the washer system 12 may divert the fluid 20 on an on-demand basis from the first component 16 to the second component 18 or from the second component 18 to the first component 16. Importantly, the washer system 12 may minimize fluid waste caused by fluid overflow from an at least first outlet port 22 upon switching to an at least second outlet port 24, as set forth in more detail below. That is, the washer system 12 may minimize fluid “burping” or leaking or backflow from the at least first or second outlet ports 22, 24 when switching between washing the first component 16 and washing the second component 18.

As described with continued reference to FIG. 1, the washer system 12 further includes a reservoir 26 defining a cavity 28 and configured for storing the fluid 20. For example, the reservoir 26 may be a windshield washer fluid tank or a tank configured for storing a valve fluid.

The washer system 12 also includes a valve assembly 14. The valve assembly 14 may be characterized as a diverter valve and may toggle or switch fluid distribution between an inlet port 30 and the at least first outlet port 22 or the at least second outlet port 24. In particular, the valve assembly 14 includes a shuttle 32 reversibly translatable with respect to an axis 34. For example, the axis 34 may be a longitudinal axis and the shuttle 32 may translate along the longitudinal axis. In another non-limiting example, the axis 34 may be an axis of rotation and the shuttle 32 may rotate about the axis of rotation. The shuttle 32 defines the at least first outlet port 22, the at least second outlet port 24 spaced apart from the at least first outlet port 22, and the inlet port 30. Although not shown, the valve assembly 14 may include any number of outlet ports 22, 24 and/or inlet ports 30. For example, the valve assembly 14 may include three or more outlet ports 22, 24 and/or two or more inlet ports 30. In another embodiment, although not shown, the shuttle 32 may be a rotary element that is rotatable about the axis 34. The at least first outlet port 22 and the at least second outlet port 24 may be arranged radially about the axis 34 of rotation, and the shuttle 32 may rotate to select the outlet port 22, 24.

Referring now to FIGS. 1 and 2, the valve assembly 14 also includes an actuator 36 configured for translating the shuttle 32 with respect to the axis 34 between a first position 38 (FIG. 1) in which the at least first outlet port 22 and the inlet port 30 are disposed in fluid communication, and a second position 40 (FIG. 2) in which the at least second outlet port 24 and the inlet port 30 are disposed in fluid communication.

The actuator 36 is formed from a shape memory alloy 42 transitionable between a first state 44 (FIG. 1) and a second state 46 (FIG. 2) in response to a thermal activation signal 48, e.g., heat such as from Joule heating or an electric current passed through resistance, or from an external heat source such as a radiative heating element, a ceramic heating element, and the like. Therefore, as set forth in more detail below, the shape memory alloy 42 transitions between the first state 44 and the second state 46 to translate the shuttle 32 from the first position 38 to the second position 40.

As used herein, the terminology “shape memory alloy 42” refers to alloys that exhibit a shape memory effect and have the capability to quickly change properties in terms of stiffness, spring rate, and/or form stability. That is, the shape memory alloy 42 may undergo a solid state crystallographic phase change via molecular or crystalline rearrangement to shift between a martensite phase, i.e., “martensite”, and an austenite phase, i.e., “austenite”. That is, the shape memory alloy 42 may undergo a displacive transformation rather than a diffusional transformation to shift between martensite and austenite. A displacive transformation is defined as a structural change that occurs by the coordinated movement of atoms or groups of atoms relative to neighboring atoms or groups of atoms. Further, the martensite phase generally refers to the comparatively lower-temperature phase and is often more deformable than the comparatively higher-temperature austenite phase.

The temperature at which the shape memory alloy 42 begins to change from the austenite phase to the martensite phase is known as the martensite start temperature, Ms. The temperature at which the shape memory alloy 42 completes the change from the austenite phase to the martensite phase is known as the martensite finish temperature, Mf, or transformation temperature, Ttrans. Similarly, as the shape memory alloy 42 is heated, the temperature at which the shape memory alloy 42 begins to change from the martensite phase to the austenite phase is known as the austenite start temperature, As. The temperature at which the shape memory alloy 42 completes the change from the martensite phase to the austenite phase is known as the austenite finish temperature, A_{f}; or transformation temperature, Ttrans.

The shape memory alloy 42 may have any suitable form, i.e., shape. For example, the shape memory alloy 42 may be configured as a shape-changing element such as a wire, spring, first resilient member 50, tape, band, continuous loop, and combinations thereof. Further, the shape memory alloy 42 may have any suitable composition. In particular, the shape memory alloy 42 may include in combination an element selected from the group of cobalt, nickel, titanium, indium, manganese, iron, palladium, zinc, copper, silver, gold, cadmium, tin, silicon, platinum, and gallium. For example, suitable shape memory alloys 42 may include nickel-titanium based alloys, nickel-aluminum based alloys, nickel-gallium based alloys, indium-titanium based alloys, indium-cadmium based alloys, nickel-cobalt-aluminum based alloys, nickel-manganese-gallium based alloys, copper based alloys (e.g., copper-zinc alloys, copper-aluminum alloys, copper-gold alloys, and copper-tin alloys), gold-cadmium based alloys, silver-cadmium based alloys, manganese-copper based alloys, iron-platinum based alloys, iron-palladium based alloys, and combinations of one or more of each of these combinations. The shape memory alloy 42 can be binary, ternary, or any higher order so long as the shape memory alloy 42 exhibits a shape memory effect, e.g., a change in shape orientation, damping capacity, and the like. Generally, the shape memory alloy 42 may be selected according to desired operating temperatures of the device 10, washer system 12, and valve assembly 14. In one specific example, the shape memory alloy 42 may include nickel and titanium.

Therefore, in one non-limiting example, the shape memory alloy 42 may be configured as a wire 142. The wire 142 formed from the shape memory alloy 42 may be characterized by the first state 44 (FIG. 1), i.e., when a temperature of the shape memory alloy 42 is below the martensite finish temperature, Mf, or transformation temperature, Ttrans, of the shape memory alloy 42. Likewise, the wire 142 formed from the shape memory alloy 42 may also be characterized by the second state 46 (FIG. 2), i.e., when the temperature of the shape memory alloy 42 is above the austenite finish temperature, A_{f}, or transformation temperature, Ttrans, of the shape memory alloy 42. In addition, although not shown, the device 10, washer system 12, and/or valve assembly 14 may include a plurality of shape memory alloys 42 and/or a plurality of wires 142. Further, in some embodiments, the shape memory alloy 42 may contact the fluid 20. That is, the actuator 36 may be disposed in and/or surrounded by the fluid 20.

Referring again to FIGS. 1 and 2, the valve assembly 14 may further include the first resilient member 50, e.g., a spring, attached to the shuttle 32 and configured for translating the shuttle 32 from the second position 40 (FIG. 2) to the first position 38 (FIG. 1) as the shape memory alloy 42 cools. For example, the shuttle 32 may be configured as a cylinder and may have a first end 52 and a second end 54 spaced apart from the first end 52. In addition, although not shown, the shuttle 32 may include additional elements or features which prevent or allow rotation. The first resilient member 50 may be attached to the first end 52, and the actuator 36 may be attached to the second end 54. In one non-limiting example, the actuator 36 may be configured as a wire 142 that contracts in length in response to the thermal activation signal 48 to thereby translate the shuttle 32 from the first position 38 to the second position 40. In another non-limiting example, the actuator 36 may be configured as a second resilient member 242 or spring that compresses in response to the thermal activation signal 48 to thereby translate the shuttle 32 from the second position 40 to the first position 38. That is, the first resilient member 50 may return the shuttle 32 to the first position 38, i.e., may bias the shuttle 32 to the first position 38, when the thermal activation signal 48 is removed from the shape memory alloy 42. As such, the first position 38 may be characterized as a starting or default position.

In another non-limiting embodiment, the first resilient member 50 may also be formed from the shape memory alloy 42. That is, the valve assembly 14 may include two or more opposing actuators 36, e.g., in the form of wires 142 and/or springs formed from the shape memory alloy 42, and each attached to opposite ends 52, 54 of the shuttle 32. For example, a first actuator 36 may be attached to the first end 52 and a second actuator 36 may be attached to the second end 54 of the shuttle 32. During operation, the first actuator 36 formed from the shape memory alloy 42 may translate the shuttle 32 in a first direction with respect to the axis 34, and the second actuator 36 formed from the shape memory alloy 42 may translate the shuttle 32 in a second direction that is opposite the first direction with respect to the axis 34. For example, the first actuator 36 may translate the shuttle 32 from a default or starting position, and the second actuator 36 may return the shuttle 32 to the default or starting position after translation. After actuation of the first actuator 36, e.g., by exposing the shape memory alloy 42 to the thermal activation signal 48, and translation of the shuttle 32 from, for example, the first position 38 to the second position 40, friction between the valve assembly 14 and any seals disposed on the shuttle 32 may retain the shuttle 32 in the last-translated position, i.e., the second position 40, until the second actuator 36 is actuated to again return the shuttle 32 to the starting or default position, i.e., the first position 38.

As described with continued reference to FIGS. 1 and 2, the washer system 12 also includes a pump 56 configured for transmitting the fluid 20 under pressure from the reservoir 26 to the inlet port 30. The pump 56 may deliver the fluid 20 to from the inlet port 30 to one of the at least first outlet port 22 and the at least second outlet port 24 depending on whether the shuttle 32 is disposed in the first position 38 (FIG. 1) or the second position 40 (FIG. 2).

The washer system 12 may further include a first output line 58 or conduit disposed in fluid communication with the at least first outlet port 22. Likewise, the washer system 12 may also include a second output line 60 or conduit disposed in fluid communication with the at least second outlet port 24.

Moreover, the device 10 includes a first nozzle 62 disposed in fluid communication with the at least first outlet port 22 and configured for spraying the fluid 20 onto the first component 16. That is, the first output line 58 may be connected to and disposed in fluid communication with the at least first outlet port 22 and the first nozzle 62. Similarly, the device 10 includes a second nozzle 64 disposed in fluid communication with the at least second outlet port 24 and configured for spraying the fluid 20 onto the second component 18, e.g., the rear liftgate window or a lens of a camera. That is, the second output line 60 may be connected to and disposed in fluid communication with the at least second outlet port 24 and the second nozzle 64.

Therefore, during operation of the washer system 12 and valve assembly 14, the shape memory alloy 42 may transition from the first state 44 (FIG. 1) to the second state 46 (FIG. 2) in response to the thermal activation signal 48, e.g., Joule heating, to translate the shuttle 32 from the first position 38 (FIG. 1) to the second position 40 (FIG. 2) such that the second nozzle 64 sprays the fluid 20 onto the second component 18. Concurrently, the shuttle 32 may seal the at least first outlet port 22 so that the pump 56 is not disposed in fluid communication with the at least first outlet port 22 and the first nozzle 62 does not spray the fluid 20 onto the first component 16. That is, the valve assembly 14 may provide a tight seal of the at least first outlet port 22 so that any fluid leaks from the first nozzle 62 onto the first component 16 are minimized while the second component 18 is washed.

Conversely, when the thermal activation signal 48 is removed from the shape memory alloy 42, the shape memory alloy 42 may cool and transition from the second state 46 (FIG. 2) to the first state 44 (FIG. 1) so that the first resilient member 50 or coil spring, i.e., the return spring, translates the shuttle 32 from the second position 40 (FIG. 2) to the first position 38 (FIG. 1) such that the first nozzle 62 sprays the fluid 20 onto the first component 16. Concurrently, the shuttle 32 may seal the at least second outlet port 24 so that the pump 56 is not disposed in fluid communication with the at least second outlet port 24 and the second nozzle 64 does not spray the fluid 20 onto the second component 18. That is, the valve assembly 14 may provide a tight seal of the at least second outlet port 24 so that any fluid leaks from the second nozzle 64 onto the second component 18 are minimized while the first component 16 is washed.

Therefore, the valve assembly 14 may be characterized as a normally-open valve assembly in which the shape memory alloy 42 closes off the at least first outlet port 22 when the valve assembly 14 is actuated, or a normally-closed valve assembly in which the shape memory alloy 42 opens the at least first outlet port 22 when the valve assembly 14 is actuated. Alternatively, the valve assembly 14 may feed or channel the fluid 20 to the at least first outlet port 22 during standard operation, and may feed or channel the fluid 20 to the at least second outlet port 24 when washing the second component 18 of the device 10 is desired. For embodiments which include more than two outlet ports 22, 24, the valve assembly 14 may also provide fluid 20 to more than one portion or component of the device 10 other than the first component 16. For example, for embodiments including three outlet ports (not shown), the valve assembly 14 and washer system 12 may alternately provide the fluid 20 to the first component 16, the rear liftgate window, and a lens of a camera of the device 10.

Referring now to FIG. 3, the method 66 of alternately washing one of the first component 16 of the device 10 and the second component 18 of the device 10 includes applying 68 the thermal activation signal 48 (FIG. 1) to the actuator 36 formed from the shape memory alloy 42. Concurrent to applying 68, the method 66 includes translating 70 the shuttle 32 with respect to the axis 34 from the first position 38 (FIG. 1) to the second position 40 (FIG. 2) to thereby wash the second component 18. After applying 68, the method 66 includes cooling 72 the shape memory alloy 42 so that the shape memory alloy 42 transitions from the second state 46 (FIG. 2) to the first state 44 (FIG. 1). Concurrent to cooling 72, the method 66 includes contracting 74 the first resilient member 50 to thereby pull the shuttle 32 from the second position 40 to the first position 38 and thereby wash the first component 16.

The method 66 may further include, concurrent to applying 68, sealing off the at least first outlet port 22 so that the inlet port 30 and the at least first outlet port 22 are not disposed in fluid communication. Conversely, the method 66 may further include, concurrent to cooling 72, sealing off the at least second outlet port 24 so that the inlet port 30 and the at least second outlet port 24 are not disposed in fluid communication.

Therefore, the device 10, washer system 12, valve assembly 14, and/or method 66 may provide a shape memory alloy-controlled, on-demand valve that is capable of switching fluid supply between the at least first outlet port 22 and the at least second outlet port 24. Such switching may be useful for applications requiring alternately washing the first component 16 and the second component 18 of the device 10 while minimizing fluid leaks from the first nozzle 62 and second nozzle 64. The device 10, washer system 12, valve assembly 14, and method 66 may also minimize priming the first output line 58 and/or the second output line 60 with fluid 20. Further, the washer system 12 and valve assembly 14 may be economically sized, may contribute to decreased manufacturing costs for the device 10, and may minimize the number of pumps 56 or other components required for multi-outlet port 22, 24 applications.

While the best modes for carrying out the disclosure have been described in detail, those familiar with the art to which this disclosure relates will recognize various alternative designs and embodiments for practicing the disclosure within the scope of the appended claims.

1. A valve assembly comprising:
a shuttle reversibly translatable with respect to an axis and defining:
an at least first outlet port;
an at least second outlet port spaced apart from the at least first outlet port; and
an inlet port; and
an actuator configured for translating the shuttle with respect to the axis between:
a first position in which the at least first outlet port and the inlet port are disposed in fluid communication; and
a second position in which the at least second outlet port and the inlet port are disposed in fluid communication;
wherein the actuator is formed from a shape memory alloy transitionable between a first state and a second state in response to a thermal activation signal.

2. The valve assembly of claim 1, wherein the shape memory alloy transitions between the first state and the second state to translate the shuttle from the first position to the second position.

3. The valve assembly of claim 2, further including a first resilient member attached to the shuttle and configured for translating the shuttle from the second position to the first position as the shape memory alloy cools.

4. The valve assembly of claim 3, wherein the shuttle is configured as a cylinder and has a first end and a second end spaced apart from the first end, and further wherein:
the first resilient member is attached to the first end; and
the actuator is attached to the second end and configured as a wire that contracts in length in response to the thermal activation signal to thereby translate the shuttle from the first position to the second position.

5. The valve assembly of claim 3, wherein the shuttle is configured as a cylinder and has a first end and a second end spaced apart from the first end, and further wherein:
the first resilient member is attached to the first end; and
the actuator is attached to the second end and configured as a second resilient member that compresses in response to the thermal activation signal to thereby translate the shuttle from the second position to the first position.

6. The valve assembly of claim 1, wherein the shuttle is rotatable about the axis.

7. A washer system comprising:
a reservoir defining a cavity and configured for storing a fluid within the cavity;
a valve assembly including:
a shuttle reversibly translatable with respect to an axis and defining:
an at least first outlet port;
an at least second outlet port spaced apart from the at least first outlet port; and
an inlet port; and
an actuator configured for translating the shuttle with respect to the axis between:
a first position in which the at least first outlet port and the inlet port are disposed in fluid communication; and
a second position in which the at least second outlet port and the inlet port are disposed in fluid communication;
wherein the actuator is formed from a shape memory alloy transitionable between a first state and a second state in response to a thermal activation signal; and
a pump configured for transmitting the fluid under pressure from the reservoir to the inlet port.

8. The washer system of claim 7, wherein the shape memory alloy contacts the fluid.

9. The washer system of claim 7, further including a first output line disposed in fluid communication with the at least first outlet port.

10. The washer system of claim 7, further including a second output line disposed in fluid communication with the at least second outlet port.

11. A device comprising:
a first component;
a second component spaced apart from the first component and exposed to debris;
a washer system configured for alternately washing one of the first component and the second component, the washer system including:
a reservoir defining a cavity and configured for storing a fluid within the cavity;
a valve assembly including:
a shuttle reversibly translatable with respect to an axis and defining:
an at least first outlet port;
an at least second outlet port spaced apart from the at least first outlet port; and
an inlet port; and
an actuator configured for translating the shuttle with respect to the axis between:
a first position in which the at least first outlet port and the inlet port are disposed in fluid communication; and
a second position in which the at least second outlet port and the inlet port are disposed in fluid communication;
wherein the actuator is formed from a shape memory alloy transitionable between a first state and a second state in response to a thermal activation signal; and
a pump configured for transmitting the fluid under pressure from the reservoir to the inlet port;
a first nozzle disposed in fluid communication with the at least first outlet port and configured for spraying the fluid onto the first component; and
a second nozzle disposed in fluid communication with the at least second outlet port and configured for spraying the fluid onto the second component.

12. The device of claim 11, wherein the washer system further includes:
a first output line connected to and disposed in fluid communication with the at least first outlet port and the first nozzle; and
a second output line connected to and disposed in fluid communication with the at least second outlet port and the second nozzle.

13. The device of claim 11, wherein the shape memory alloy transitions from the first state to the second state in response to the thermal activation signal to translate the shuttle from the first position to the second position such that the second nozzle sprays the fluid onto the second component.

14. The device of claim 13, wherein the shuttle seals the at least first outlet port so that the pump is not disposed in fluid communication with the at least first outlet port and the first nozzle does not spray the fluid onto the first component.

15. The device of claim 11, wherein the valve assembly further includes a first resilient member attached to the shuttle and configured for translating the shuttle from the second position to the first position as the shape memory alloy cools.

16. The device of claim 15, wherein the shape memory alloy cools and transitions from the second state to the first state so that the first resilient member translates the shuttle from the second position to the first position such that the first nozzle sprays the fluid onto the first component.

17. The device of claim 16, wherein the shuttle seals the at least second outlet port so that the pump is not disposed in fluid communication with the at least second outlet port and the second nozzle does not spray the fluid onto the second component.
